(19) United States
(12) Patent Application Publication
(10) Pub. No.: US 2013/0166307 A1
(43) Pub. Date: Jun. 27, 2013

(54) Efficient Implementation of Phase Shift Filtering for Decorrelation and Other Applications in an Audio Coding System

(71) Applicant: Stephen D. Vernon, Hillsborough, CA (US)

(72) Inventor: Stephen D. Vernon, Hillsborough, CA (US)

(73) Assignee: DOLBY LABORATORIES LICENSING CORPORATION, San Francisco, CA (US)

(21) Appl. No.: 13/820,087

(22) PCT Filed: Sep. 6, 2011
(86) PCT No.: PCT/US2011/050557

§ 371 Date: Feb. 28, 2013

Related U.S. Application Data
(60) Provisional application No. 61/385,487, filed on Sep. 22, 2010.

(51) Int. Cl. G10L 19/02

(52) U.S. Cl. CPC G10L 19/02
USPC 704/500

(57) ABSTRACT

An analysis/synthesis system uses existing analysis and synthesis filterbanks in an audio coding system to implement a phase shift filter that requires very little if any additional processing. One implementation using a single processing path can obtain a phase shift of either zero or ninety degrees. Another implementation that uses two processing paths can obtain a phase shift of essentially any desired angle.

### CROSS-REFERENCE TO RELATED APPLICATIONS

This application claims priority to U.S. Provisional Patent Application No. 61/385,487 filed 22 Sep. 2010, hereby incorporated by reference in its entirety.

### TECHNICAL FIELD

The present invention pertains generally to signal processing methods that may be used in audio coding systems, and it pertains more specifically to processing methods that may be used to implement phase-shift filters efficiently.

### BACKGROUND ART

A variety of audio coding system standards exist that are capable of presenting five or more channels of sound in a playback environment. A few examples include those described in the “Digital Audio Compression Standard (AC-3, E-AC-3),” Revision B, Document A/52B, 14 Jun. 2005 published by the Advanced Television Systems Committee, Inc. (referred to herein as the “ATSC Standard”), and in ISO/IEC 13818-7, Advanced Audio Coding (AAC) (referred to herein as the “MPEG-2 AAC Standard”) and ISO/IEC 14496-3, subpart 4 (referred to herein as the “MPEG-4 Audio Standard”) published by the International Standards Organization (ISO). Systems that conform to the ATSC Standard and these MPEG standards, for example, are capable of presenting six channels of audio in a so-called 5.1 channel configuration that includes left, right, center, left-surround, right-surround (L, R, C, LS, RS) channels and a low-frequency-effects (LFE) channel.

Many consumers do not have systems that are capable of reproducing all of the channels that these standards support. As a result, the playback units in these systems generally provide a means for downmixing all of the channels that are capable of separate presentation into a fewer number of channels such as two channels for conventional stereophonic reproduction.

The way in which these channels are downmixed is important if the resulting signals are to be processed properly by existing channel-expansion technologies. These channel-expansion technologies are capable of expanding two-channel stereo program material into four or more channels. One example of such a technology is used in a Dolby® Pro Logic® II decoder described in Gundry, “A New Active Matrix Decoder for Surround Sound,” 19th AES Conference, May 2001. Many of these expansion technologies use phase differences in two-channel stereo signals to steer output signals into different channels for playback. For example, signals in the left and right channels that are in-phase with one another and have equal amplitude are steered into the center channel, signals that are in only the left channel or in only the right channel are steered into the left channel or right channel, respectively, and signals in the left and right channels that have opposite phase and equal amplitude are steered into surround channels.

Preferably, a multichannel audio system should be capable of downmixing their program material into a two-channel stereo format that is compatible with existing channel-expansion technologies. The downmixing equations are generally similar to the following:

Lt=L+0.707*C+0.707*(Ls+Rs)

Rt=R+0.707*C−0.707*(Ls+Rs)

where Lt=the downmixed material for the left channel; and

Rt=the downmixed material for the right channel.

These equations ensure the signals intended for a particular playback channel are encoded with the phase and amplitude relationships needed for sound-expansion to work correctly.

These downmix equations can also create undesirable side effects. If a high amount of correlation exists between the center-channel signal and the sum of the two surround-channel signals, then the downmix equations can cause unintended cancellations. For example, the signal mixing that occurs according to the term 0.707*C−0.707*(Ls+Rs) can cause the center-channel and surround-channel signals to cancel one another. In this situation, signals that are intended to create the aural effect of a sound moving from the front to the back of a listing area could instead create the impression of the sound starting at the front and taking a sharp turn to the left-hand side of the listening area.

One conventional solution to avoid this side effect is to use a phase decorrelation filter in the surround-sound channels. In the ideal case, a perfect ninety degree phase shift filter is used to process the surround-sound channels. This allows a sound that is panned electronically from front to back to remain balanced in the Lt/Rt downmix, thereby avoiding the cancellation phenomenon described above.

Unfortunately, large amounts of computational resources are required to implement conventional ninety degree phase shift filters. Implementations using a finite impulse response filter often require the execution of as many as 30 million instructions per second and can introduce 13 msec or more of signal-processing delays. Simplified implementations such as those based on complementary infinite impulse response filters or based on combinations of filters and delays are also possible but these approaches typically introduce non-linear characteristics that result in poor frequency response or poor decorrelation at certain frequencies and can require significant amounts of computational resources.

What is needed is an efficient technique that can achieve good signal decorrelation between channels of audio signals in typical multichannel coding systems without incurring the problems introduced by other known techniques.

### DISCLOSURE OF INVENTION

It is an object of the present invention to provide for an efficient implementation of a phase-shift filter in a wide variety of audio signal processing systems.

The present invention may be used advantageously to implement filters that achieve a ninety degree phase shift, or other amounts of phase shift, in audio coding systems that use any of a wide variety of transforms to convert audio signals into and out of frequency-domain or spectral-domain representations.

According to one aspect of the invention that provides for a phase shift, a forward transform is applied to a source audio signal to generate a spectral-domain representation of that signal, and an inverse transform is applied to audio information that is equal to or is derived from the spectral-domain representation to generate an output signal that approximates the source audio signal shifted in phase by ninety degrees. The forward transform operates according to a first set of basis functions and the inverse transform operates according to a second set of basis functions in which each basis function is in quadrature with a corresponding basis function in the first set of basis functions. In preferred implementations, a high-pass filter is inserted somewhere in the signal processing path between the source signal and the output signal to remove the lowest-frequency spectral components.

Other aspects of the present invention are discussed in the following disclosure. The various features of the present invention and its preferred implementations may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF DRAWINGS

FIG. 1 is a schematic block diagram of a transmitter in an audio coding system that may incorporate various aspects of the present invention.

FIG. 2 is a schematic block diagram of a receiver in an audio coding system that may incorporate various aspects of the present invention.

FIG. 3 is a graphical representation of total harmonic distortion plus noise of a phase shift filter implemented according to teachings of the present invention.

FIG. 4A is a schematic block diagram of a portion of a receiver that uses two synthesis filterbanks to obtain a phase shift of either zero or ninety degrees.

FIG. 4B is a polar plot that illustrates the phase shift of zero and ninety degrees.

FIG. 5A is a schematic block diagram of a portion of a receiver that uses two synthesis filterbanks to obtain a phase shift of essentially any amount.

FIG. 5B is a polar plot that illustrates four quadrants of phase shift.

FIG. 6 is a schematic block diagram of a device that may be used to implement various aspects of the present invention.

### MODES FOR CARRYING OUT THE INVENTION

### A. Overview

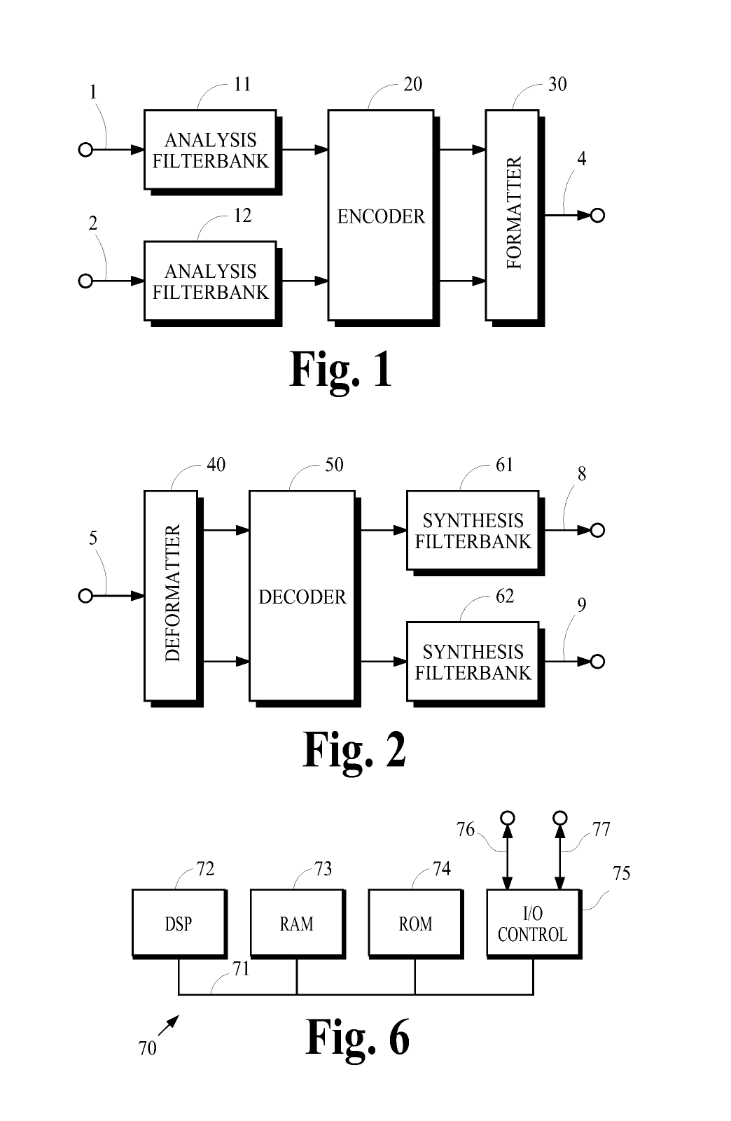

FIG. 1 illustrates an exemplary transmitter in an audio coding system that is suitable for incorporating various aspects of the present invention. In this transmitter, an analysis filterbank 11 is applied to a first source audio signal that is received from the path 1 to generate first audio information representing spectral content of the first source audio signal. The encoder 20 is applied to the first audio information to generate first encoded information. The formatter 30 assembles the first encoded information into an output signal that is passed along the path 4.

In a two-channel application, the transmitter applies an analysis filterbank 12 to a second source audio signal that is received from the path 2 to generate second audio information representing spectral content of the second source audio signal. The encoder 20 is applied to the second audio information to generate second encoded information. The formatter 30 assembles the second encoded information into the output signal.

Additional audio channels may be processed as desired by applying additional analysis filterbanks to additional source audio signals. Only two channels are shown in the figure for illustrative clarity.

The analysis filterbank 11 is implemented by a first forward transform and the analysis filterbank 12 is implemented by a second forward transform. Additional details are discussed below.

The encoder 20 may employ essentially any coding process that may be desired. In preferred implementations, the encoder 20 applies coding processes to generate encoded information that conforms to any of a number of international standards such as the ATSC Standard, the MPEG-2 AAC Standard and the MPEG-4 Audio Standard mentioned above, or other so-called perceptual audio coding systems. No particular coding process is essential to the present invention. Principles of the present invention may be used with coding systems that conform to other specifications. For example, the encoder 20 may employ coding processes that merely encode the first audio information into a digital representation that is suitable for transmission or storage.

The formatter 30 may assemble the output signal into any form that is suitable for transmission or storage. No particular assembly process is critical. For example, the formatter 30 may multiplex the encoded information with encoder metadata, error detection codes or error correction codes, database retrieval keys, or communication-channel synchronization codes into a serial bitstream that can be stored and subsequently retrieved or transmitted and received for decoding by a suitable receiver.

FIG. 2 illustrates an exemplary receiver in an audio coding system that is suitable for incorporating various aspects of the present invention. In this receiver, a deformatter 40 is applied an encoded input signal received from the path 5 to obtain first encoded information. The decoder 50 is applied to the first encoded information to obtain first audio information representing spectral content of a first source audio signal. The synthesis filterbank 61 is applied to the first audio information to generate a replica of the first source audio signal along the path 8.

The signal that is generated along the path 8 is a replica of the first audio signal but it may not be an exact replica because of information lost due to coding processes or because of errors due to finite-precision arithmetic used to implement the filterbanks.

In two-channel applications, the deformatter 40 also obtains second encoded information from the encoded input signal and the decoder 50 is applied to the second encoded information to obtain second audio information representing spectral content of a second source audio signal. A synthesis filterbank 62 is applied to the second audio information to generate a replica of the second source audio signal along the path 9.

Additional audio channels may be processed as desired by applying additional synthesis filterbanks to additional channels of encoded information obtained from the encoded input signal. Only two channels are shown in the figure for illustrative clarity.

The deformatter 40 disassembles the encoded input signal into encoded information and other data using a disassembly process. No particular disassembly process is critical but it should be complementary to the assembly process used to assemble information into the encoded signal. For example, the encoded input signal may be a bitstream that contains encoder metadata, error detection codes or error correction codes, or communication-channel synchronization codes and the deformatter 40 demultiplexes the bitstream into its respective parts.

The decoder 50 may employ essentially any decoding process that may be desired. In preferred implementations, the decoder 50 applies processes to decode encoded information that conforms to standards or systems like those mentioned above. No particular decoding process is essential to the present invention but the decoder 50 typically should employ a decoding process that is complementary to processes applied by the encoder 20 to convert the encoded information into another format suitable for subsequent processing by the synthesis filterbanks.

The synthesis filterbank 61 is implemented by a first inverse transform and the synthesis filterbank 62 is implemented by a second inverse transform. Additional details are discussed below.

The present invention may be used in a variety of audio-signal processing systems such as, for example, systems that implement multiband audio equalizers that do not use coding process. The processes and functions represented by the encoder 20 and the decoder 50 are not essential to practice the present invention and may be omitted if desired.

### B. Analysis and Synthesis Filterbanks

### 1. Introduction

The analysis and synthesis filterbanks discussed above may be implemented by a wide variety of transforms. Implementations for a particular analysis/synthesis system may use forward transforms for the analysis filterbanks and complementary or inverse transforms for the synthesis filterbanks. No particular choice of transform is critical for the present invention. Forward transforms like the Discrete Cosine Transform (DCT) and the Modified Discrete Cosine Transform (MDCT) are examples of transforms that may be used.

Forward transforms like the Type-II DCT and the oddly-stacked MDCT generate a representation of the spectral content of a source signal that consists of a set of coefficients representing respective weights or proportions of basis functions. These basis functions define operational characteristics of the transform. The set of basis functions for the DCT and MDCT is a set of harmonically related cosine functions, which are non-complex functions because they can be represented by pure real numbers.

Complementary inverse transforms like the Type-II Inverse DCT (IDCT), which corresponds to a Type-III DCT, and the oddly-stacked Inverse MDCT (IMDCT) synthesize a replica of a source signal from its spectral representation. In conventional use, the inverse transform synthesizes a replica of the source signal without any change in phase because it operates according to the same set of basis functions as those for the forward transform that was used to generate the spectral representation.

The present invention uses combinations of forward and inverse transforms that do not operate according to the same basis functions. Instead, the basis functions of the inverse transform are in quadrature with corresponding basis functions of the forward transform. For example, if the forward transform basis functions are harmonically-related cosine functions, the inverse transform basis functions could harmonically-related sine functions. By using the transforms in this manner, the inverse transform is able to synthesize a signal that is nearly in quadrature with the source signal. This processing technique may be used advantageously in existing coding systems to obtain an approximation of a ninety degree phase-shifted version of a source signal. Very little if any additional processing is needed because the computationally intensive portions of the phase-shift process are already performed by the coding system to implement the analysis and synthesis filterbanks. The only additional processing that may be needed is the processing used to adapt either the forward transform or the inverse transform to operate according to a different set of basis functions.

The following discussion illustrates principles that can be used to adapt the basis functions for an analysis/synthesis system implemented by the oddly-stacked MDCT and IMDCT. The same principles apply to analysis/synthesis systems that are implemented by other transforms like the DCT and IDCT.

### 2. Modified Discrete Cosine Transform

The present invention is capable of implementing a phase-shift decorrelating filter in conventional coding systems that achieves a nearly perfect ninety degree phase shift. For example, coding systems that conform to ATSC Standard and the MPEG-2 AAC standard mentioned above use the oddly-stacked MDCT to implement analysis filterbanks in the transmitters and use the oddly-stacked IMDCT to implement synthesis filterbanks in the receivers. The transmitter applies a MDCT to a source signal to generate a spectral representation of the source signal. The spectral representation consists of a set of transform coefficients, which are quantized according to psychoacoustic principles and assembled into an encoded output signal. A companion receiver obtains the set of quantized transform coefficients from its encoded input signal, dequantizes them to obtain a spectral representation of the source signal, and applies an IMDCT to the spectral representation to obtain a replica of the source signal.

As noted above, the MDCT and IMDCT operate according to a set of basis functions that are harmonically-related cosine functions.

A Modified Discrete Sine Transform (MDST) exists that corresponds to the MDCT but it operates according a set of basis functions that are harmonically-related sine functions. Similarly, an Inverse Modified Discrete Sine Transform (IMDST) exists that is an inverse to the MDST and corresponds to the IMDCT but it operates according a set of basis functions that are harmonically-related sine functions.

If a conventional coding system like those described above is adapted to retain the MDCT in the transmitter but replace the IMDCT with the IMDST in the receiver, the output signal that is generated by the receiver is nearly in quadrature with the source signal. Similarly, if a conventional coding system like those described above is adapted to replace the MDCT with the MDST in the transmitter and retain the IMDCT in the receiver, the output signal that is generated by the receiver is nearly in quadrature with the source signal.

The phase shift that is achieved by this analysis/synthesis processing technique is not perfect. Noise and distortion are generated at frequencies near zero and near the Nyquist frequency; however, this is not a unique deficiency of this particular technique. This same situation also exists for many other types of ninety degree phase shift filters. Fortunately, this characteristic does not introduce any serious problem for many applications where the phase of spectral components near zero frequency have little if any significance and the amplitudes of spectral components near the Nyquist frequency are seldom significant. Acceptable results for these types of applications can be achieved by introducing a band-pass filter somewhere along the signal processing path between receipt of the source signal and output of its replica. In many applications, a high-pass filter is sufficient because essentially no spectral energy exists near the Nyquist frequency.

In one implementation of a coding system, the transmitter is modified to have an appropriate high-pass filter and an analysis filterbank implemented by a MDST. This approach allows a system to exploit benefits of the present invention without requiring any modification to existing receivers. Furthermore, if phase-shift filtering is being implemented to decorrelate signals, the transmitter may adapt or control the phase shift using information about its input source signals that will not be available to the receiver by analyzing the source signals to decide whether the signals in two channels are sufficiently correlated. If the signals are not sufficiently correlated, the transmitter can use a MDCT to implement the analysis filterbank for both channels in a conventional manner. If the signals are sufficiently correlated, the transmitter can use a MDST to implement the analysis filterbank for one of the channels.

In another implementation of a coding system, the receiver is modified to have an appropriate high-pass filter and a synthesis filterbank implemented by an IMDST. This approach allows the receiver to perform phase-shift filtering only when signals are being downmixed or when some other process is being performed that benefits from the phase shift.

This approach may also improve encoding efficiency in the transmitter for coding processes that perform better with correlated signals. So-called mid-side coding and channel coupling processes are two examples. If desired, the transmitter can analyze its input signals to determine the degree to which its input source signals are correlated and assemble control information into its encoded output signal that represents this determination. The receiver can respond to this control information by controlling whether phase-shift filtering is performed.

As noted above, a band-pass filter or a high-pass filter may be inserted at any point into the signal processing path. For example, in yet another implementation of a coding system, the transmitter implements a high-pass filter and the receiver replaces its IMDCT synthesis filterbank with an IMDST filterbank.

Regardless of implementation, the present invention takes advantage of the fact that the processing needed to perform the MDCT and MDST and their respective inverse transforms is so closely related that very few if any additional computational resources are needed to switch between them. This may be seen from a review of the underlying signal processing equations discussed below.

### 3. Processing Equations

The following paragraphs discuss the oddly-stacked MDCT and its inverse transform. The transforms were first discussed in Princen, et al., “Subband/Transform Coding Using Filter Bank Designs Based on Time Domain Aliasing Cancellation,” ICASSP 1987 Conf. Proc., May 1987, pp. 2161-64. The paper describes these transforms as the time-domain equivalent of an oddly-stacked critically sampled single-sideband analysis/synthesis system.

The oddly-stacked MDCT may be expressed as shown in the following equation:

$${X}_{C} ( k ) = \frac{1}{N} {\sum }_{n = 0}^{N - 1} x ( n ) w ( n ) cos ( \frac{2 π ( n + {n}_{0} ) ( k + {k}_{0} )}{N} ) \\ for 0 \leq k < N \qquad ( 1 )$$

where x(n)=sample n of a source signal x;

w(n)=sample n of a window function w;

n0=0.25 N+0.5;

k0=0.5;

N=transform length in numbers of samples; and

XC(k)=transform coefficient XC representing spectral component k.

This transform operates according to a set a basis functions that are harmonically-related cosine functions.

A transform that operates according to a set of basis functions that are in quadrature with the basis functions of the MDCT may be expressed as shown in the following equation:

$${X}_{S} ( k ) = \frac{1}{N} {\sum }_{n = 0}^{N - 1} x ( n ) w ( n ) sin ( \frac{2 π ( n + {n}_{0} ) ( k + {k}_{0} )}{N} ) \\ for 0 \leq k < N \qquad ( 2 )$$

where XS(k)=transform coefficient XS representing spectral component k.
This transform is referred to herein as a Modified Discrete Sine Transform (MDST) and it operates according to a set of basis functions that are harmonically-related sine functions.

An IMDCT that is inverse to the MDCT shown above may be expressed as shown in the following equation:

$${x}_{C} ( n ) = 4 w ( n ) {\sum }_{k = 0}^{\frac{N}{2} - 1} {X}_{C} ( k ) cos ( \frac{2 π ( n + {n}_{0} ) ( k + {k}_{0} )}{N} ) \\ for 0 \leq n < N \qquad ( 3 )$$

where xC(n)=sample n of the signal xC recovered by the IMDCT.
This transform operates according to a set a basis functions that are harmonically-related cosine functions.

An Inverse Modified Discrete Sine Transform (IMDST), which is inverse to the MDST, operates according to a set of basis functions that are in quadrature with the basis functions of the IMDCT. The IMDST may be expressed as shown in the following equation:

$${x}_{S} ( n ) = 4 w ( n ) {\sum }_{k = 0}^{\frac{N}{2} - 1} {X}_{S} ( k ) sin ( \frac{2 π ( n + {n}_{0} ) ( k + {k}_{0} )}{N} ) \\ for 0 \leq n < N \qquad ( 4 )$$

where xS(n)=sample n of the signal xS recovered by the IMDST.
This transform operates according to a set a basis functions that are harmonically-related sine functions.

Principles of the present invention may be illustrated by considering a sinusoidal source signal of the form:

$$x ( n ) = sin ( \frac{2 π fn}{{F}_{S}} + φ ) \qquad ( 5 )$$

where f=frequency of the source signal x;

FS=sample rate of the source signal; and

φ=phase of the source signal.

Two terms are defined to simplify derivations discussed below. The terms are:

$$\begin{matrix}α = \frac{2 π fn}{{F}_{S}} + φ & ( 6 ) \\ β = \frac{2 π ( n + {n}_{0} ) ( k + {k}_{0} )}{N} & ( 7 )\end{matrix}$$

If an ideal ninety degree phase shift filter is applied to the source signal x(n), the signal y(n) that is obtained may be expressed as:

$$y ( n ) = sin ( \frac{2 π fn}{{F}_{S}} + φ + \frac{π}{2} ) = cos ( \frac{2 π fn}{{F}_{S}} + φ ) \qquad ( 8 )$$

If a MDCT is applied to the signal y(n), the resulting spectral representation YC(k) can be expressed as:

$${Y}_{C} ( k ) = \frac{1}{N} {\sum }_{n = 0}^{N - 1} w ( n ) cos ( α ) cos ( β ) \qquad ( 9 )$$

Using a known trigonometric identify, this expression can be written as:

$$\begin{matrix}{Y}_{C} ( k ) = \frac{1}{N} {\sum }_{n = 0}^{N - 1} w ( n ) cos ( α ) cos ( β ) \\ = \frac{1}{N} {\sum }_{n = 0}^{N - 1} w ( n ) [ sin ( α ) sin ( β ) + cos ( α + β ) ] \\ = \frac{1}{N} {\sum }_{n = 0}^{N - 1} w ( n ) sin ( α ) sin ( β ) + \frac{1}{N} {\sum }_{n = 0}^{N - 1} w ( n ) cos ( α + β ) \\ = {X}_{S} ( k ) + \frac{1}{N} {\sum }_{n = 0}^{N - 1} w ( n ) cos ( α + β )\end{matrix} \qquad ( 10 )$$

This last expression shows that the spectral representation YC(k) obtained by applying the MDCT to the ninety degree phase-shifted signal y(n) is almost identical to the spectral representation YS(k) obtained by applying the MDST to the source signal x(n). The difference between the two spectral representations may be expressed as an error term E(k):

$$E ( k ) = \frac{1}{N} {\sum }_{n = 0}^{N - 1} w ( n ) cos [ 2 π ( \frac{fn}{{F}_{S}} + φ + \frac{( n + {n}_{0} ) ( k + {k}_{0} )}{N} ) ] \qquad ( 11 )$$

### 4. Error Analysis

One way to assess the significance of this error term is to apply an IMDCT to both spectral representations YC(k) and YS(k) to obtain two signals yCC(n) and xSC(n) and compare the signals to calculate a value representing Total Harmonic Distortion plus Noise (THD+N). For this analysis, the signal yCC(n) is the desired noise-free signal and the signal xSC(n) is the signal that contains distortion and noise E(k) as shown in expression 11.

Application of the IMDCT to obtain the two signals may be expressed as:

$$\begin{matrix} {y}_{CC} ( n ) = 4 w ( n ) {\sum }_{k = 0}^{\frac{N}{2} - 1} {Y}_{C} ( k ) cos ( \frac{2 π ( n + {n}_{0} ) ( k + {k}_{0} )}{N} ) & ( 12 ) \\ {x}_{SC} ( n ) = 4 w ( n ) {\sum }_{k = 0}^{\frac{N}{2} - 1} {X}_{S} ( k ) cos ( \frac{2 π ( n + {n}_{0} ) ( k + {k}_{0} )}{N} ) & ( 13 ) \\ A normalized value for T H D + N may be calculated as follows \text{:} \\ T H D + N = \sqrt{\frac{{\sum }_{n = 0}^{N - 1} {( {x}_{SC} ( n ) - {y}_{CC} ( n ) )}^{2}}{{\sum }_{n = 0}^{N - 1} {( {y}_{CC} ( n ) )}^{2}}} & ( 14 )\end{matrix}$$

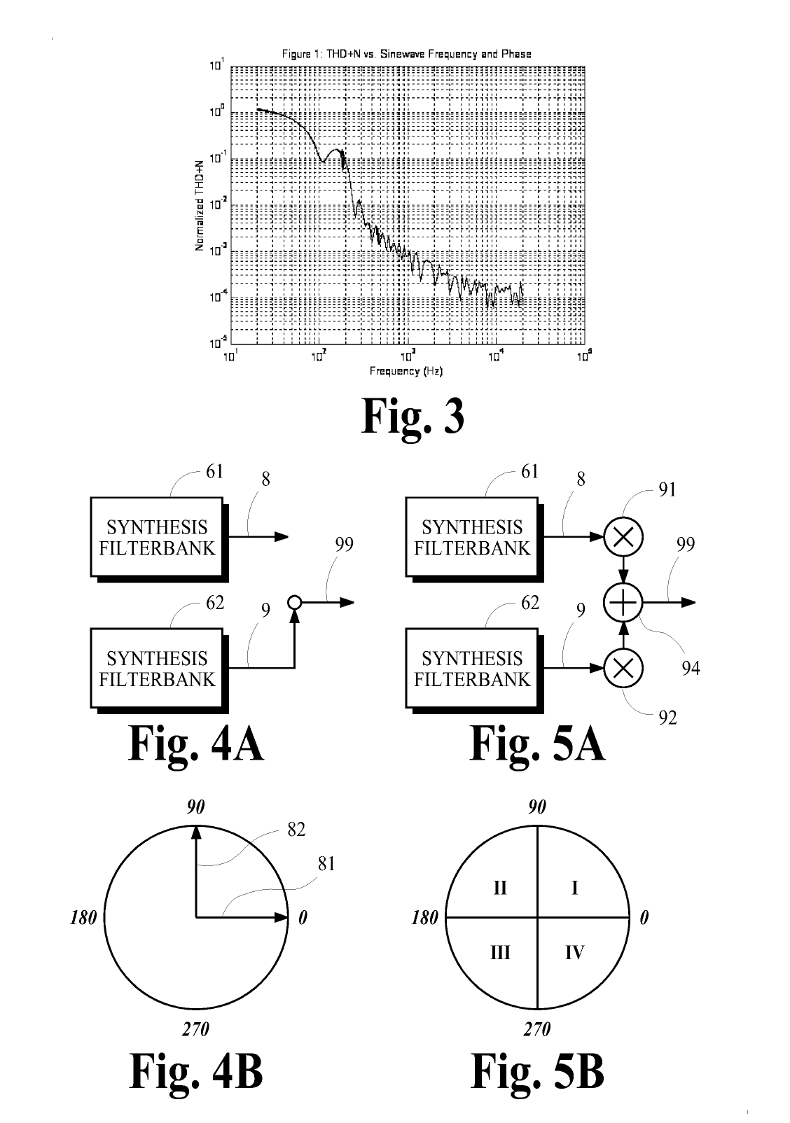

FIG. 3 illustrates this normalized error value for the transforms shown above in expressions 1 to 3, where N=512 and FS=48 kHz for sinusoidal source signals x(n) having the form shown in expression 5. The graph illustrates error values for a range of frequencies f and a range of initial phase angles φ. The graph shows the THD+N for low-frequency signals below about 200 Hz is greater than 10% but the THD+N for frequencies above about 1 kHz is less than 0.1%. The graph does not show that THD+N increases to about 10% for frequencies near the Nyquist frequency.

As may be seen from FIG. 3, the MDST/IMDCT analysis/synthesis system operates very well as a ninety degree phase shift filter over a significant portion of the spectrum and it may be used in many applications by confining the phase-shift output to all but the lowest and highest frequencies. Similar results may be obtained from a MDCT/IMDST system. As mentioned above, for many applications there is no appreciable signal energy for frequencies near the Nyquist frequency; therefore, a high-pass filter is sufficient for these applications. Listening experiments indicate a suitable cutoff frequency fHPF for the high-pass filter may be calculated as a function of sample frequency FS and MDCT length N as follows:

$${f}_{HPF} = \frac{4 {F}_{S}}{N} \qquad ( 15 )$$

For an implementation in which N=512 and FS=48 kHz, the cutoff frequency is 375 Hz. The maximum THD+N within the passband of the filter is 0.4%.

It may be helpful to note that the results achieved for the analysis/synthesis systems described above is not limited to sinusoidal source signals but is applicable to any source signal. This may be readily understood by recognizing these transforms are linear and any signal can be represented by a linear combination of sinusoidal signals.

### C. Variations in Implementation

The analysis/synthesis system described above may be implemented in a variety of ways, the filterbanks may be adapted in response to signal characteristics or other factors, and additional filterbanks may be incorporated into the system to provide for phase shifts of any angle. These variations are discussed in the following paragraphs.

### 1. One Channel

The single-channel analysis/systems presented above are discussed here in connection with FIGS. 1 and 2. The analysis filterbank 12 and the synthesis filterbank 62 are not needed for these implementations. A single-channel analysis/synthesis system may be incorporated into a coding system that processes any number of other channels. For example, a single-channel analysis/synthesis system that is implemented according to the present invention can be applied to one of the channels in a 5.1 channel coding system as described above and all other channels can be processed in a conventional manner.

Referring to the exemplary transmitter shown in FIG. 1, a first source audio signal is received from the path 1. A first forward transform that implements the analysis filterbank 11 is applied to the first audio signal to generate first audio information representing spectral content of the first source audio signal. The first forward transform operates according to a first set of basis functions. The basis functions in the first set of basis functions may be non-complex functions.

The encoder 20 encodes the output of the analysis filterbank 11 and the formatter 30 assembles this encoded information into an encoded output signal that is passed along the path 4. The encoded output signal is destined for decoding by a receiver such as the exemplary receiver shown in FIG. 2.

The implementation of the analysis filterbank 11 may be adapted in response to a control signal. For example, the filterbank may be implemented by either a MDCT or a MDST in response to a control signal that is obtained in any way that may be desired. The control signal may be received from an operator or it may be generated by a component that analyzes the source signal. One example analyzes the signals in two channels to determine the degree of correlation between them. If the degree of correction exceeds a threshold, the filterbank may be adapted to provide for phase-shift filtering.

Referring to the exemplary receiver shown in FIG. 2, first audio information is obtained from an encoded input signal that is received from the path 5. The first audio information represents spectral content of a first source audio signal that was generated by application of a first forward transform to the first source audio signal. The first forward transform operated according to a first set of basis functions. The basis functions in the first set of basis functions may be non-complex functions. A first inverse transform that implements the synthesis filterbank 61 is applied to the first audio information to obtain a first audio signal that is passed along the path 8. The first inverse transform operates according to a second set of basis functions in which each basis function is in quadrature with a corresponding basis function of the first set of basis functions.

The implementation of the synthesis filterbank 61 may be adapted in response to a control signal. For example, the filterbank may be implemented by either a IMDCT or a IMDST in response to a control signal that is obtained in any way that may be desired. The control signal may be received from an operator, it may be generated by a component that analyzes the audio information obtained from the encoded input signal, or it may be obtained from information in the encoded input signal that was provided by the transmitter.

The basis functions for the analysis/synthesis systems discussed above as well as the analysis/synthesis systems discussed below may be cosine and sine functions. The various filterbanks may be implemented by various combinations of the MDCT, MDST, IMDCT and IMDST. Other transforms may be used including all types of DCT and DST and their respective inverse transforms.

### 2. Two Channels

The single-channel analysis/synthesis system discussed above may be expanded to process an additional channel using the analysis filterbank 12 and the synthesis filterbank 62. A multichannel coding system may incorporate this two-channel analysis/synthesis system along with the components needed to process one or more other channels.

The two-channel analysis/synthesis system performs all of the processes mentioned above for the single-channel system. The transmitter and receiver also perform additional processes for the second channel.

In addition to the processes described above, the transmitter also receives a second source audio signal from the path 2. A second forward transform that implements the analysis filterbank 12 is applied to the second source audio signal to generate second audio information. The second audio information represents spectral content of the second source audio signal. The encoder 20 encodes the second audio information and the formatter 30 assembles this encoded information into the encoded output signal.

In addition to the processes described above, the receiver obtains encoded information from the encoded input signal and applies the decoder 50 to this encoded information to obtain second audio information. A second inverse transform that implements the synthesis filterbank 62 is applied to the second audio information to obtain a second audio signal, which is passed along the path 9.

This two-channel analysis/synthesis system may be implemented in at least two ways.

In one implementation, the first forward transform operates according to a first set of basis functions, the second forward transform operates according to a second set of basis functions in which each basis function is in quadrature with a corresponding basis function in the first set of basis functions, and both the first inverse transform and the second inverse transform operate according to the second set of basis functions. This implementation corresponds to the approach described above in which the transmitter is modified to work with existing unmodified receivers. The implementation of the analysis filterbank 11 may be adapted in response to a control signal as described above to operate according to either the first or second set of basis functions.

In another implementation, the first and second forward transforms operate according to a first set of basis functions, the first inverse transform operates according to a second set of basis functions in which each basis function is in quadrature with a corresponding basis function in the first set of basis functions, and the second inverse transform operates according to the first set of basis functions. This implementation corresponds to the approach described above in which the receiver is modified to work with an existing unmodified transmitter. The implementation of the synthesis filterbank 61 may be adapted in response to a control signal as described above to operate according to either the first or second set of basis functions.

Either of these two implementations may be used to decorrelate channels in a coding system that downmixes two or more of its channels. For example, the two channels in the two-channel analysis/synthesis system may correspond to the left- and right-surround channels in a 5.1 channel coding system. One of the surround channels is processed by an analysis/synthesis system that shifts the phase of its signal by ninety degrees to decorrelate one surround-sound channel with respect to the other. The two channels can then be combined or downmixed without creating the undesirable side effects mention above.

### 3. Arbitrary Phase Shift

An implementation of the receiver in FIG. 2 can also be used to implement a filter that can provide essentially any desired angle of phase shift. In this implementation, the synthesis filterbank 61 and the synthesis filterbank 62 are applied to audio information for the same audio channel. The synthesis filterbank 61 is implemented by a first inverse transform that operates according to a first set of basis functions. The synthesis filterbank 62 is implemented by a second inverse transform that operates according to a second set of basis functions in which each basis function is in quadrature with a corresponding basis function in the first set of basis functions. The audio information was generated by applying a forward transform to a source audio signal. The forward transform may have operated according to either the first or second set of basis functions.

The first inverse transform operates according to the same set of basis functions that governed the operation of the forward transform. As a result, the first inverse transform recovers a replica of the source audio signal without any phase shift. The second inverse transform operates according to a set of basis functions that are in quadrature with the basis functions of the forward transform. As a result, the second inverse transform generates an approximation of the source signal with a ninety degree phase shift as explained above.

The receiver can provide an output signal representing either no change in phase or a ninety degree phase shift by switching between the outputs of the two inverse transforms. This is illustrated schematically by the diagram in FIG. 4A and the polar plot shown in FIG. 4B. When the output of the second inverse transform is connected to the output signal path 99 as shown in the figure, the phase of the output signal with respect to the source audio signal is shifted by ninety degrees as shown by the phasor 82 in FIG. 4B. When the output of the first inverse transform is connected to the output signal path 99, the phase of the output signal with respect to the source audio signal is zero degrees as shown by the phasor 81 in FIG. 4B.

Another implementation of the receiver shown in FIG. 5A is capable of producing an output signal having essentially any desired phase relative to the source audio signal. This is achieved by obtaining a weighted combination of the zero degree phase shifted signal from the first inverse transform and the ninety degree phase shifted signal from the second inverse transform. The implementation shown in FIG. 5A obtains the weighted combination by multiplying the output of each inverse transform by an appropriate factor and then adding the multiplied signals. The weighted combination needed to obtain a particular angle θ of phase shift may be expressed as:

x₀(n)=sin θ·x₁(n)+cos θ·x₂(n) (16)

where x₁(n)=the signal generated by the first inverse transform;

x₂(n)=the signal generated by the second inverse transform; and

x₀(n)=the output signal with the desired phase shift.

The same result can be achieved by multiplying the inputs to the inverse transforms by the same factors and combining their outputs.

Either implementation described above is able to achieve a phase shift in any of the four quadrants I to IV of the polar plot as shown in FIG. 5B. For example, a phase shift of 150 degrees in quadrant II can be obtained by obtaining a weighted combination of signals using the weight sin(150)=0.500 for the signal x₁(n) and the weight cos(150)=−0.866 for the signal x₂(n).

### D. Implementation

Devices that incorporate various aspects of the present invention may be implemented in a variety of ways including software for execution by a computer or some other device that includes more specialized components such as digital signal processor (DSP) circuitry coupled to components similar to those found in a general-purpose computer. FIG. 6 is a schematic block diagram of a device 70 that may be used to implement aspects of the present invention. The processor 72 provides computing resources. RAM 73 is system random access memory (RAM) used by the processor 72 for processing. ROM 74 represents some form of persistent storage such as read only memory (ROM) for storing programs needed to operate the device 70 and possibly for carrying out various aspects of the present invention. I/O control 75 represents interface circuitry to receive and transmit signals by way of the communication channels 76, 77. In the embodiment shown, all major system components connect to the bus 71, which may represent more than one physical or logical bus; however, a bus architecture is not required to implement the present invention.

In embodiments implemented by a general purpose computer system, additional components may be included for interfacing to devices such as a keyboard or mouse and a display, and for controlling a storage device having a storage medium such as magnetic tape or disk, an optical medium, or a solid-state information storage medium. The storage medium may be used to record programs of instructions for operating systems, utilities and applications, and may include programs that implement various aspects of the present invention.

The functions required to practice various aspects of the present invention can be performed by components that are implemented in a wide variety of ways including discrete logic components, integrated circuits, one or more ASICs and/or program-controlled processors. The manner in which these components are implemented is not important to the present invention.

Software implementations of the present invention may be conveyed by a variety of machine readable media such as baseband or modulated communication paths throughout the spectrum including from supersonic to ultraviolet frequencies, or storage media that convey information using essentially any recording technology including magnetic tape, cards or disk, optical cards or disc, solid-state devices, and detectable markings on media including paper.

What is claimed is:

1-13. (canceled)

14. A method that comprises:
receiving an input signal that conveys first audio information representing spectral content of a first source audio signal that was generated by application of a first forward transform to the first source audio signal, wherein the first forward transform operated according to a first set of basis functions;
applying a first inverse transform to the first audio information to obtain a first audio signal, wherein the first inverse transform operates according to a second set of basis functions in which each basis function is in quadrature with a corresponding basis function of the first set of basis functions; and
generating an output signal that represents the first audio signal.

15. The method of claim 14 that comprises:
obtaining second audio information from the input signal that represents spectral content of a second source audio signal, wherein the second audio information was generated by application of the first forward transform to the second source audio signal;
applying a second inverse transform to the second audio information to obtain a second audio signal, wherein the second inverse transform operates according to the first set of basis functions; and
generating a second output signal that represents the second audio signal.

16. The method of claim 14 that comprises:
obtaining control information from the input signal; and
adapting the first inverse transform in response to the control information to operate according to the first set of basis functions.

17. The method of claim 14 that comprises:
obtaining second audio information from the input signal that represents spectral content of a second source audio signal, wherein the second audio information was generated by application of a second forward transform to the second source audio signal, wherein the second forward transform operated according to the second set of basis functions;
applying the first inverse transform to the second audio information to obtain a second audio signal; and
generating a second output signal that represents the second audio signal.

18. The method of claim 15 that comprises combining the first output signal and the second output signal.

19. The method of claim 14 that comprises:
applying a second inverse transform to the first audio information to obtain a second audio signal, wherein the second inverse transform operates according to the first set of basis functions; and
generating the output signal from a combination of the first audio signal and the second audio signal.

20. A method that comprises:
receiving a first source audio signal;
applying a first forward transform to the first source audio signal to generate first audio information representing spectral content of the first source audio signal, wherein the first forward transform operates according to a first set of basis functions; and assembling the first audio information into an output signal that is destined for a receiver that will obtain a representation of the first audio information from the output signal, and apply an inverse transform to the representation of the first audio information, wherein the inverse transform operates according to a second set of basis functions in which each basis function is in quadrature with a corresponding basis function of the first set of basis functions.

21. The method of claim 20 that comprises:
receiving a second source audio signal;
applying a second forward transform to the second source audio signal to generate second audio information representing spectral content of the second source audio signal, wherein the second forward transform operates according to the second set of basis functions; and
assembling the second audio information into the output signal.

22. The method of claim 20 that comprises:
receiving a control signal; and
adapting the first forward transform in response to the control signal to operate according to the second set of basis functions.

23. The method of claim 14, wherein either:
the basis functions in the first set of basis functions are cosine functions and the basis functions of the second set of basis functions are sine functions; or
the basis functions in the first set of basis functions are sine functions and the basis functions of the second set of basis functions are cosine functions.

24. The method of claim 23, wherein:
forward transforms that operate according to basis functions that are cosine functions are Modified Discrete Cosine Transforms;
forward transforms that operate according to basis functions that are sine functions are Modified Discrete Sine Transforms;
inverse transforms that operate according to basis functions that are cosine functions are Inverse Modified Discrete Cosine Transforms; and
inverse transforms that operate according to basis functions that are sine functions are Inverse Modified Discrete Sine Transforms.

25. An apparatus that comprises a respective means for performing each of the steps in the method of claim 14.

26. A computer-readable storage medium that records a program of instructions that is executable by a computer to perform the steps in the method of claim 14.
